(19) United States
(12) Patent Application Publication
(10) Pub. No.: US 2008/0082225 A1
(43) Pub. Date: Apr. 3, 2008

(54) A METHOD OF REPORTING ERRORS IN MAP DATA USED BY NAVIGATION DEVICES

(75) Inventor: Michael Barrett, Essex (GB)

Correspondence Address: SYNNESTVEDT LECHNER & WOODBRIDGE LLP, P O BOX 592, 112 NASSAU STREET, PRINCETON, NJ, 08542-0592, US

(73) Assignee: TOMTOM INTERNATIONAL B.V., Amsterdam (NL)

(21) Appl. No.: 11/464,609

(22) Filed: Aug. 15, 2006

(51) Int. Cl. G05D 1/00; G01C 22/00

(52) U.S. Cl. 701/26

(57) ABSTRACT

An end-user can input a map error report to a map error, directly on the device. The device stores the map error report and can send the report to a remote server for processing. Hence, it is no longer necessary for an end-user to simply report errors to the map vendor over a web link, then wait for that map vendor to verify the error, update its maps and finally supply the end-user with updates—a cycle that can take months and sometimes years to complete.

### FIELD OF THE INVENTION

This invention relates to a method of reporting errors in map data used by navigation devices. Navigation devices include GPS based electronic personal navigation devices.

### DESCRIPTION OF THE PRIOR ART

Map data for electronic navigation devices, such as GPS based personal navigation devices like the GO™ from TomTom International BV, comes from specialist map vendors such as Tele Atlas NV. This map data is specially designed to be used by route guidance algorithms, typically using location data from the GPS system. For example, roads can be described as lines—i.e. vectors (e.g. start point, end point, direction for a road, with an entire road being made up of many hundreds of such sections, each uniquely defined by start point/end point direction parameters). A map is then a set of such road vectors, data associated with each vector (speed limit; travel direction etc.) plus points of interest (POIs), plus road names, plus other geographic features like park boundaries, river boundaries etc, all of which are defined in terms of vectors. All map features (e.g. road vectors, POIs etc.) are typically defined in a co-ordinate system that corresponds with or relates to the GPS co-ordinate system, enabling a device's position as determined through a GPS system to be located onto the relevant road shown in a map and for an optimal route to be planned to a destination.

To construct this map database, Tele Atlas starts with basic road information from various sources, such as the Ordnance Survey for roads in England. It also has a large, dedicated team of vehicles driving on roads, plus personnel checking other maps and aerial photographs, to update and check its data. This data constitutes the core of the Tele Atlas map database. This map database is being continuously enhanced with geo-referenced data. It is then checked and published four times a year to device manufacturers like TomTom.

Despite the huge resources that go into updating and verifying these maps, the data for some geographic areas may be a year or more out of date.

In addition to the ongoing improvements described above, end-users can directly report map errors to Tele Atlas using Tele Atlas' web site. Device manufacturers like TomTom also capture and forward map error reports from their users in this way. These error reports are generally just in a free text format, so that considerable effort has to be expended in working out what the error really means and what exact location they relate to. Once verified as a real error, the appropriate map error report is validated and the correction included in a future map release. The correction may eventually find itself in an end-user device a year or more after first being notified or, in some cases, not at all.

It is also known to store a ‘trace’ of a journey planned and completed using a GPS satellite navigation device (see for example the ‘GPS track submission’ functionality offered by ALK Technologies of Princeton, USA). This trace is a record of the complete route taken by a vehicle, using geo-coded data. The user can then send this trace data back to the device vendor; it is then used to improve the accuracy and completeness of the map database. For example, the precise position of a road or a turning may not be accurately captured on a map used by a device; the aggregated tracks for people taking that road or turning will enable a more accurate position to be determined; future map releases by the device vendor can incorporate the map error report.

Reference may also be made to collaborative mapping projects, frequently called ‘wikimaps’. Wikimaps do not however generate ‘map data’ as we define that term—i.e. map data that is suitable for route guidance algorithms to plot a route on a road system to a destination.

### SUMMARY OF THE INVENTION

The invention is a method of reporting errors in map data used by navigation devices, the method comprising the steps of:
a) displaying map data, suitable for route guidance algorithms, on an electronic navigation device;
b) an end-user of the device inputting a map error report, directly on the device;
c) the device storing that map error report;
d) the device sending that map error report to a remote server that can process that map error report.

The map error report itself can be stored as a text entry with a location reference or geo-reference; this geo-reference is obtained from GPS data generated by the device. A typical map error report could be a report that the name of a road is incorrect. The map error report can be sent back to the server as part of synchronisation. Because the map error report is geo-referenced, it is much easier to accurately locate and hence rapidly validate. The remote server can send the map error reports to the original provider of the map data, or some commercial arrangement arrived at. For example, the entity controlling the server could reduce the license fees it pays to a provider of the map data in exchange for supplying the map error reports.

A second aspect of the invention is map data for a navigation device that has been developed at least in part using the method defined above.

A third aspect is an electronic navigation device storing map data as defined above.

A fourth aspect is an electronic navigation device adapted to store improved map data, the device:
a) displaying map data;
b) enabling an end-user to input a map error report, directly on the device; and
c) the device storing that map error report;
d) the device sending that map error report to a remote server that can process that map error report.

The device can be a portable stand-alone device including a touch screen. It can be a PDA.

### BRIEF DESCRIPTION OF THE DRAWINGS

The present invention will be described with reference to the accompanying drawings, in which

FIG. 1 is the main error reporting screen displayed by a navigation device;

FIG. 2 is the screen that allows users to define the type of error they wish to report;

FIG. 3 is a screen shot from a navigation device implementing the present invention; the screen shot shows a plan map view and a status bar running along the bottom of the display;

FIG. 4 is a screen shot from the navigation device implementing a 3-D view;

FIG. 5 is a screen shot from the navigation device showing a navigation menu;

FIGS. 6A and 6B are perspective views of the navigation device; and

FIG. 7 is a schematic view of the system architecture for the navigation device;

FIG. 8 is a block diagram of components in the navigation device;

FIG. 9 is a diagram of the electrical subassemblies in the FIG. 8 navigation device.

### DETAILED DESCRIPTION

With an implementation of the present invention, it is no longer necessary for an end-user to be restricted to reporting errors to the map vendor over a web link, then waiting for that map vendor to verify the error, update its maps and supply the update—a cycle that can take months and sometimes years to complete. Instead, the navigation device itself allows a user to input a required map error report; the device can then automatically geo-reference the map error report if necessary. Geo-referencing may not be needed for all map error reports. For example, a name change to a road does not. But a width restriction preventing lorries entering a road should be.

The device then stores this map error report and sends it (directly or indirectly) to a server that aggregates the map error reports and, typically, sends those reports to a map vendor (or in some cases the device manufacturer). The map error reports are used to construct appropriate corrections. Hence, later releases of maps (e.g. pre-installed on new devices; or made available via the internet to existing device users) can include the correction.

This is a much more convenient way of capturing map map error reports and ensuring that they are rapidly incorporated into later releases of maps. The navigation device can be a portable stand-alone GPS navigation device with route guidance capability, such as the GO series device from TomTom International BV, or any other kind of portable information device, such as a mobile telephone, PDA or other touch screen device. But equally, it could be a device integrated into a vehicle, or a computing device such as a static desktop PC (including a laptop) running navigation software (which term includes mapping software which does not actually deliver dynamic route guidance but instead simply mapping—i.e. merely an indication of where the user is. Also, the navigation software could run locally on the client device or run on a server remote from the client device).

To re-cap, typical features of such a navigation device are:
A user interface allowing users to create map error reports to a digitally stored map;
Automatically geo-referencing map error reports if appropriate;
The ability to upload map map error reports to a remote server.

The map fix can be reported to a TomTom server by the device in a number of ways: the device may have an integral communications capability (e.g. wireless cellular system that can send data to the server); may be able to send data over a short range wireless link to a mobile telephone which in turn sends the data to the server; may be able to dock with an internet connected PC that can communicate with the server; or may itself be that internet connected PC. The server can then aggregate all error reports from all users and share them with one or more map vendors.

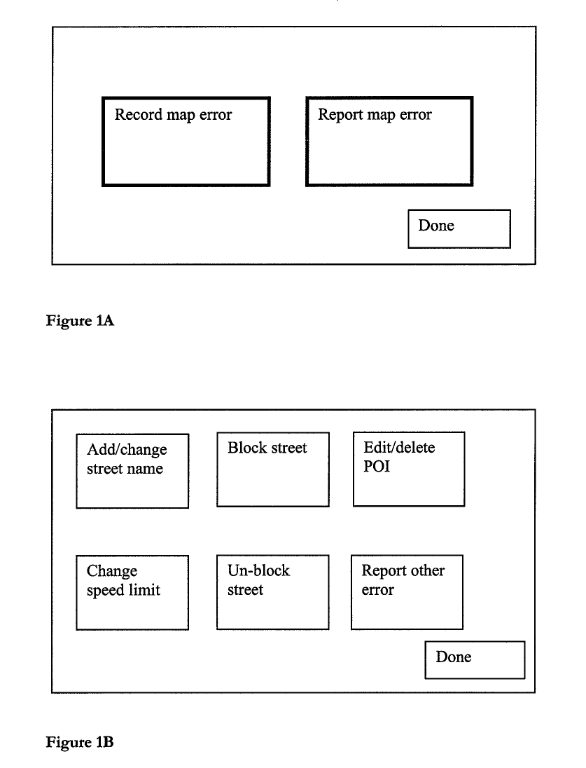

On a GO navigation device, the invention can be implemented by the device displaying a menu item ‘Record map error’, as shown in FIG. 1A. The consequences of selecting this item are discussed below. There is one further menu item that will be described first.

The menu item ‘Report map error’ allows the user to initiate an upload of the user's own map error reports to a remote server (if that is not achieved automatically in the background). Upload can, for example, be via a mobile telephone with a GPRS wireless link that links to the GO device over a Bluetooth network or via an Internet connected PC that the GO device is docked with.

If the user selects the ‘Record map error’ icon by touching it, it takes the user to a submenu which offers map error report options. These include, as shown in FIG. 1B:
Add/change street name: if a user selects this, then the device could, for example, display a list of names of streets currently being displayed by the map (or that would be displayed if the device were in the normal navigation mode); the user could select the street to be re-named and then enter the new name that should be reported via an on-screen keyboard.
Block Street: if a user selects this, then the device could, for example, display a list of names of streets currently being displayed by the map (or that would be displayed if the device were in the normal navigation mode); the user could select the street that should be reported as a street to be marked as blocked.
Change traffic direction (not shown): if a user selects this, then the device could, for example, display a list of names of streets currently being displayed by the map (or that would be displayed if the device were in the normal navigation mode) together with the traffic direction; the user could select the street that should be reported as having a different traffic direction.
Change speed limit: if a user selects this, then the device could, for example, display a list of names of streets currently being displayed by the map (or that would be displayed if the device were in the normal navigation mode) together with applicable speed limits; the user could select the street that should be reported as having an incorrect speed limit, pus an indication of what that speed limit should be.
Un-block street: if a user selects this, then the device could, for example, display a list of names of blocked streets currently being displayed by the map (or that would be displayed if the device were in the normal navigation mode); the user could select the street to be reported as a street to be unblocked.

In addition, it is possible, selecting the ‘Edit/delete POI’ icon to reach a deeper sub-menu with graphical options for the following:
Rename a POI
Move a POI
Add a POI to a category Delete a POI
Re-categorize a POI

In each case, the device could, for example, display a list of names of POIs currently being displayed by the map (or that would be displayed if the device were in the normal navigation mode); the user could select the relevant POI and then complete a report that a POI should be edited or deleted. These POIs are typically those supplied by the map vendor but can include POIs downloaded by the user (e.g. speed cameras).

A further menu item is to ‘Report other error’. This enables complaints, missing roads etc. to be reported. Typical functions will enable the user to pick a location, select from a list of typical issues, allow a user to add free text commentary etc. and then send that report.

### Other Implementation Features

The navigation device stores:
the map error report together with a unique identifier
the map error report together with a time stamp defining when the map error report was input.

Map error reports requesting the following types of correction are possible:
to block a street.
to unblock a street.
to change a speed or speed limit applicable to a street.
to rename, move, add, delete or re-categorise a POI.
to add or change a name applicable to a city, part of a city, street or a part of a street.
to change a direction of traffic property of a road.
to add a road or connect two roads.
to block access for one or more of: a motor vehicle; pedestrians; heavy goods vehicles; bicycles.
to add a turn restriction to a road.
to remove a turn restriction.
to add or modify house numbers.
to mark a road as a toll road.
to remove an indication that a road is a toll road.
to add or modify signpost information for a road.
to modify motorway exit numbers.
to modify a postcode associated with a location.
to add or modify a height, weight or width restriction.

Other features are:
the user can associate a map error report with one or more transportation types.
the map error report is compressed for OTA distribution.
the map error report is securely encoded.
map error reports are analysed by the server as to source, applicability and trustworthiness.
the server informs the user if the map error report has already been corrected in a newer version of the map data and also informs the user how they can purchase the updated map data.

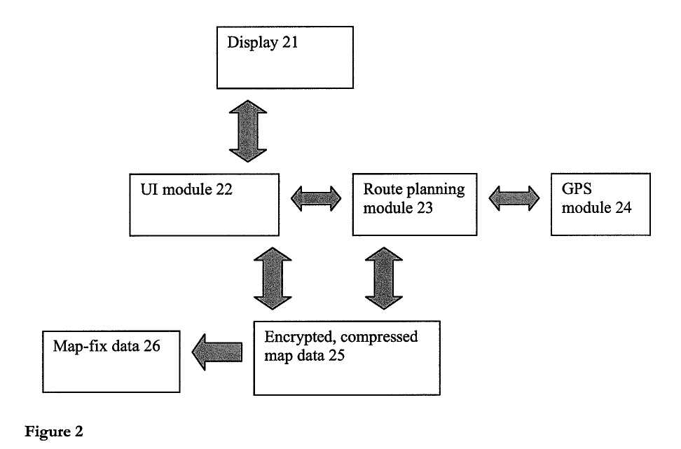

FIG. 2 shows schematically the core software modules deployed in a navigation device implementing the invention. The display 21 is a touch screen display that the user enters a destination address into in the conventional manner. That address data input is handled by the UI module 22 and sent to the navigation/route planning module 23. Route planning module 23, taking a GPS feed from GPS module 24, plans a route using map data from the encrypted, compressed map data that the device was shipped with (or was otherwise supplied from the map vendor, such as Tele Atlas). The present invention is then implemented as follows: the user enters a map error report as and when needed, using a touch screen interaction, touching large graphical icons, as exemplified by FIGS. 1A and 1B, into display 21. The UI module 22 captures the map error report and sends it to a map error report store 26. When the device next synchronises or connects with a remote map server, the map error reports stored in store 26 are automatically sent to the server. The connection mechanism depends on the device capabilities. The device could simply dock with an internet connected PC; the map fixes could be sent to the server via the PC. Or the device could send them directly to the server if it has its own data send capability (e.g. integral cellular telephony module) or it could send the data over a short range wireless link to a mobile telephone, which in turn then sends that map fix data to the server.

The term ‘server’ should be expansively interpreted as any device or collection of devices that can store data: typically, the server will be a collection of computers programmed to receive and process the incoming map error reports; the format of the map error reports will determine how the server handles the map error reports and any geo-referencing. For simple text based descriptions of map errors (e.g. “Oxford Road is now no entry from the south side”) then the text (and geo-reference) is sent to an operator (possibly at the map vendor) who can validate the map error report (e.g. comparing it with similar map error reports from other end-users; comparing it with other sources of information) and then amend the map database accordingly. That amended map database will be periodically (e.g. every 3 months) frozen and then distributed by the map vendor to all device suppliers.

Appendix 1 describes a typical device that can implement the present invention.

### Appendix 1

The present invention can be implemented in an integrated navigation device from TomTom B.V. called GO. GO deploys navigation software called Navigator (or Navcore) and has an internal GPS receiver; Navigator software can also run on a touch screen (i.e. stylus controlled) Pocket PC powered PDA device, such as the Compaq iPaq. It then provides a GPS based navigation system when the PDA is coupled with a GPS receiver. The combined PDA and GPS receiver system is designed to be used as an in-vehicle navigation system.

The invention may also be implemented in any other arrangement of navigation device, such as one with an integral GPS receiver/computer/display, or a device designed for non-vehicle use (e.g. for walkers) or vehicles other than cars (e.g. aircraft). The navigation device may implement any kind of position sensing technology and is not limited to GPS; it can hence be implemented using other kinds of GNSS (global navigation satellite system) such as the European Galileo system. Equally, it is not limited to satellite based location/velocity systems but can be deployed using ground-based beacons or any other kind of system that enables the device to determine its geographic location.

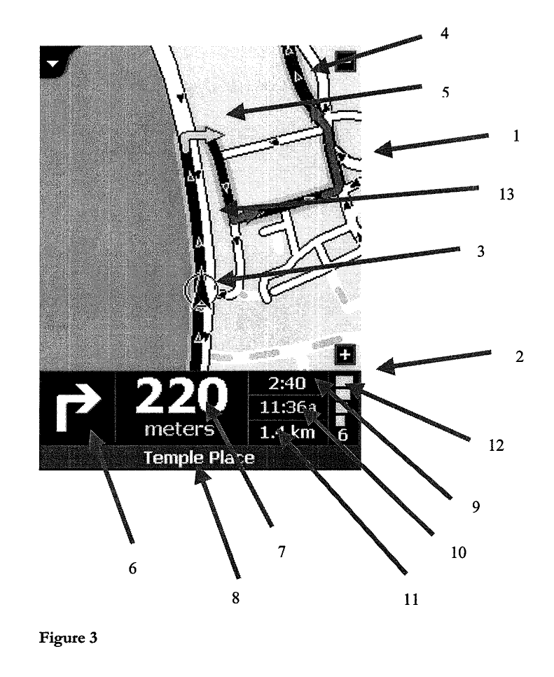

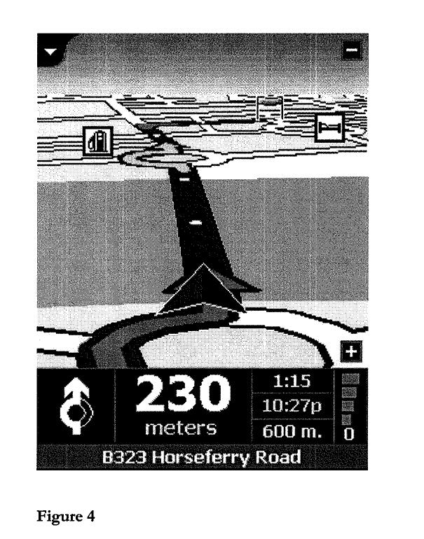

Navigator software, when running on a PDA, results in a navigation device that causes the normal navigation mode screen shown in FIG. 3 to be displayed. This view provides driving instructions using a combination of text, symbols, voice guidance and a moving map. Key user interface elements are the following: a 2-D map 1 occupies most of the screen. The map shows the user's car and its immediate surroundings, rotated in such a way that the direction in which the car is moving is always “up”. Running across the bottom quarter of the screen is the status bar 2. The current location of the device, as the device itself determines using conventional GPS location finding and its orientation (as inferred from its direction of travel) is depicted by an arrow 3. The route calculated by the device (using route calculation algorithms stored in device memory as applied to map data stored in a map database in device memory) is shown as darkened path 4 superimposed with arrows giving the travel direction. On the darkened path 4, all major actions (e.g. turning corners, crossroads, roundabouts etc.) are schematically depicted by arrows 5 overlaying the path 4. The status bar 2 also includes at its left hand side a schematic 6 depicting the next action (here, a right turn). The status bar 2 also shows the distance to the next action (i.e. the right turn—here the distance is 220 meters) as extracted from a database of the entire route calculated by the device (i.e. a list of all roads and related actions defining the route to be taken). Status bar 2 also shows the name of the current road 8, the estimated time before arrival 9 (here 2 minutes and 40 seconds), the actual estimated arrival time 10 (11.36 am) and the distance to the destination 11 (1.4 μm). The GPS signal strength is shown in a mobile-phone style signal strength indicator 12. A 3-D map view is also possible, as shown in FIG. 4.

If the user touches the screen 13, then a navigation screen main menu (not shown) is displayed; from this menu, other core navigation functions within the Navigator application can be initiated or controlled. Allowing core navigation functions to be selected from a menu screen that is itself very readily called up (e.g. one step away from the map display to the menu screen) greatly simplifies the user interaction and makes it faster and easier.

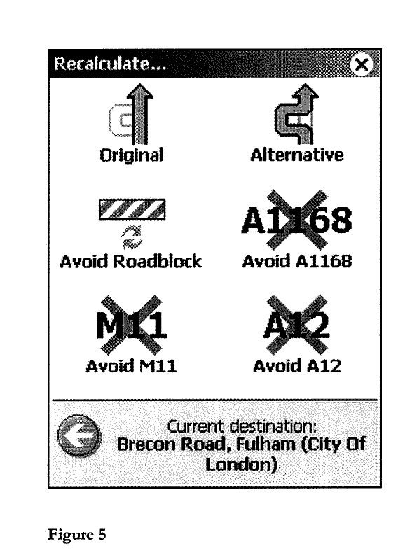

The area of the touch zone which needs to be touched by a user is far larger than in most stylus based touch screen systems. It is designed to be large enough to be reliably selected by a single finger without special accuracy; i.e. to mimic the real-life conditions for a driver when controlling a vehicle; he or she will have little time to look at a highly detailed screen with small control icons, and still less time to accurately press one of those small control icons. Hence, using a very large touch screen area associated with a given soft key (or hidden soft key, as in the centre of the screen 13) is a deliberate design feature of this implementation. Unlike other stylus based applications, this design feature is consistently deployed throughout Navigator to select core functions that are likely to be needed by a driver whilst actually driving. Hence, whenever the user is given the choice of selecting on-screen icons (e.g. control icons, or keys of a virtual keyboard to enter a destination address, for example), then the design of those icons/keys is kept simple and the associated touch screen zones is expanded to such a size that each icon/key can unambiguously be finger selected. In practice, the associated touch screen zone will be of the order of at least 0.7 cm² and will typically be a square zone. In normal navigation mode, the device displays a map. Touching the map (i.e. the touch sensitive display) once (or twice in a different implementation) near to the screen centre (or any part of the screen in another implementation) will then call up either directly (i.e. the next level down) or indirectly (i.e. two or more levels down) a navigation menu (see FIG. 5) with large icons corresponding to various navigation functions, such as the option to calculate an alternative route, and re-calculate the route so as to avoid the next section of road (useful when faced with an obstruction or heavy congestion); or recalculate the route so as to avoid specific, listed roads.

The actual physical structure of the device is fundamentally different from a conventional embedded device in terms of the memory architecture (see system Architecture section below). At a high level it is similar though: memory stores the route calculation algorithms, map database and user interface software; a microprocessor interprets and processes user input (e.g. using a device touch screen to input the start and destination addresses and all other control inputs) and deploys the route calculation algorithms to calculate the optimal route. ‘Optimal’ may refer to criteria such as shortest time or shortest distance, or some other user-related factors.

More specifically, the user inputs his start position and required destination in the normal manner into the Navigator software running on the PDA using a virtual keyboard. The user then selects the manner in which a travel route is calculated: various modes are offered, such as a ‘fast’ mode that calculates the route very rapidly, but the route might not be the shortest; a ‘full’ mode that looks at all possible routes and locates the shortest, but takes longer to calculate etc. Other options are possible, with a user defining a route that is scenic—e.g. passes the most POI (points of interest) marked as views of outstanding beauty, or passes the most POIs of possible interest to children or uses the fewest junctions etc.

Roads themselves are described in the map database that is part of Navigator (or is otherwise accessed by it) running on the PDA as lines—i.e. vectors (e.g. start point, end point, direction for a road, with an entire road being made up of many hundreds of such sections, each uniquely defined by start point/end point direction parameters). A map is then a set of such road vectors, plus points of interest (POIs), plus road names, plus other geographic features like park boundaries, river boundaries etc, all of which are defined in terms of vectors. All map features (e.g. road vectors, POIs etc.) are defined in a co-ordinate system that corresponds or relates to the GPS co-ordinate system, enabling a device's position as determined through a GPS system to be located onto the relevant road shown in a map.

Route calculation uses complex algorithms that are part of the Navigator software. The algorithms are applied to score large numbers of potential different routes. The Navigator software then evaluates them against the user defined criteria (or device defaults), such as a full mode scan, with scenic route, past museums, and no speed camera. The route which best meets the defined criteria is then calculated by a processor in the PDA and then stored in a database in RAM as a sequence of vectors, road names and actions to be done at vector end-points (e.g. corresponding to pre-determined distances along each road of the route, such as after 100 meters, turn left into street x).

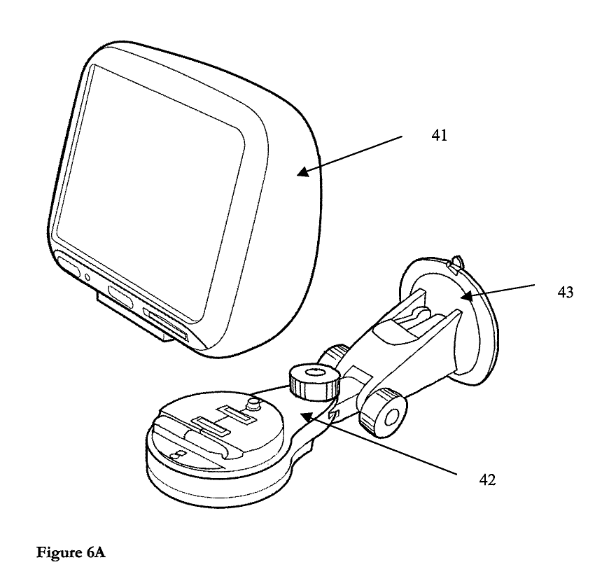

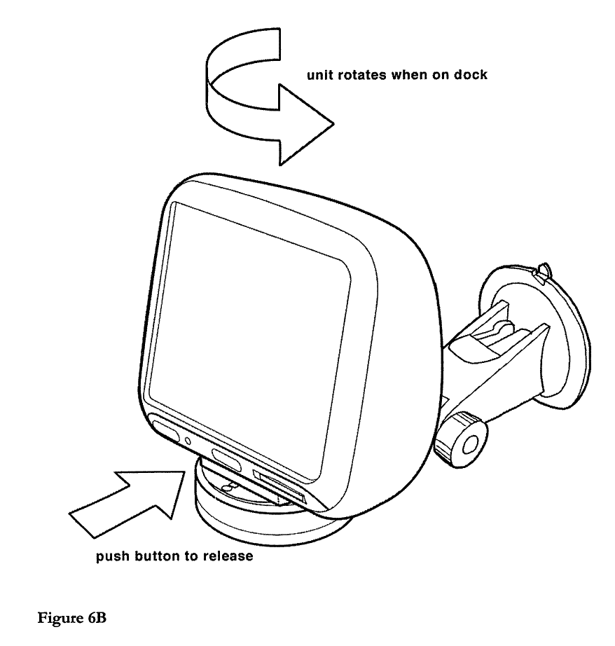

FIGS. 6A and 6B are perspective views of an actual implementation of a navigation device. The navigation device is a unit that includes display, internal GPS receiver, microprocessor, power supply and memory systems. The device sites on an arm, which itself is secured to the car dashboard using a large suction cup.

### System Architecture

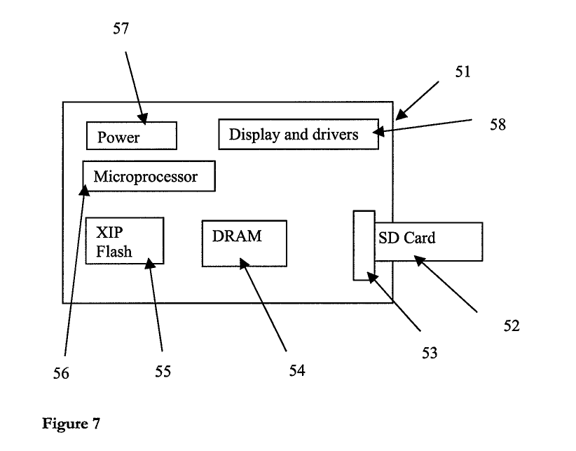

In contrast to conventional embedded devices which execute all the OS and application code in place from a large mask ROM or Flash device, an implementation of the present invention uses a new memory architecture. FIG. 7 schematically depicts the device. The device, indicated generally at 51, includes conventional items such as a microprocessor 56, power source 57, display and related rivers 58. In addition, it includes a SD card reader 53; a SD card 52 is shown slotted into position. The device 51 has internal DRAM 54 and XIP Flash 55 and.

The device hence uses three different forms of memory:
1. A small amount of internal XIP (eXecute In Place) Flash ROM 55. This is analogous to the PC's BIOS ROM and will only contain a proprietary boot loader, E² emulation (for UID and manufacturing data) and splash screen bit maps. This is estimated to be 256 KB in size and would be on a slow 8 bit wide SRAM interface.
2. The main system RAM (or DRAM) memory 54, this is analogous to the PC's main memory (EAM). This will be where all the main code executes from as well as providing the video RAM and workspace for the OS and applications. Note: No persistent user data will be stored in the main system RAM (like a PC) i.e. there will be no “Ram drive”. This RAM will be exclusively connected to a 32 bit 100 MHz synchronous high-speed bus.
3. Non-volatile storage, analogous to the PC's hard disk. This is implemented as removable NAND flash based SD cards 52. These devices do not support XIP. All the OS, application, settings files and map data will be permanently stored on SD cards

On boot up the proprietary boot loader 55 will prompt for the user to insert the supplied SD card 52. When this is done, the device will copy a special system file from the SD card 52 into RAM 54. This file will contain the Operating System and navigation application. Once this is complete control will be passed to the application. The application then starts and access non-volatile data e.g. maps from the SD card 52.

When the device is subsequently switched off, the RAM 54 contents is preserved so this boot up procedure only occurs the first time the device is used.

### GO Product Specification

### Introduction

GO is a stand-alone fully integrated personal navigation device. It will operate independently from any connection to the vehicle.

### Target Markets

GO is intended to address the general personal navigation market. In particular it is designed to extend the market for personal navigation beyond the “early adopter” market. As such it is a complete stand-alone solution; it does not require access to a PC, PDA or Internet connection. The emphasis will be on completeness and ease of use.

Although GO is a complete personal navigation solution it is primarily intended for in vehicle use. The primary target market is anybody who drives a vehicle either for business or pleasure.

To successfully address this market GO must satisfy the following top-level requirements:
1. Acceptable price point—Appropriate compromise between product features and cost.
2. Simplicity—Installation and operation of GO will be simple and intuitive, all major functions should be accomplished by an average non PC-literate user without recourse to the product manual.
3. Flexibility—All map data and operating programs will be supplied on plug in memory cards. The device can easily be extended to cover different locals.
4. Reliability—Although in-car navigation systems are not considered safety critical components users will come to rely on GO. It will be engineered to all relevant automotive environmental standards. In addition it will be tolerant to short GPS coverage outages.

### Channels

Consumer electronics retail outlets
Automotive accessory outlets
Specialist car accessory fitting garages

### Product Summary

GO is an in-vehicle personal navigation device. It is designed as an appliance, that is, for a specific function rather than a general purpose one. It is designed for the consumer after-sales automotive market. It will be simple to use and install by the end user, although a professional fitting kit will be optionally supplied.

The principal features are:
Built on standard commodity PocketPC 2002 components
Standard PocketPC 3.5″¼VGA transflective TFT LCD display mounted in landscape orientation
ROMless soft-boot memory architecture
Highly integrated ARM9 200 MHz CPU
SD card memory slot for application and map data storage
Integrated GPS receiver and antenna
Integrated two axis accelerometer for simple dead reckoning
Power, audio, debug and external GPS antenna connections made through docking connector on base of unit
Embedded Linux OS with no GUI layer, application provides its own UI
Very simple touch screen UI optimised for finger use
High quality integrated speaker for voice instructions
Internal rechargeable Li-Ion battery giving at least five hours of continuous operation

### Operating System

GO will use a customised version of embedded Linux. This will be loaded from an SD card by a custom boot-loader program which resides in Flash memory

### Hard Buttons

GO will have only one hard button, the power button. It is pressed once to turn on or off GO. The UI will be designed so that all other operations are easily accessible through the pen based UI.

There will also be a concealed hard reset button.

### Architecture

GO architecture is based around a highly integrated single chip processor designed for mobile computing devices. This device delivers approximately 200 MIPs of performance from an industry standard ARM920T processor. It also contains all the peripherals required excluding the GPS base-band. These peripherals include DRAM controller, timer/counters, UARTs, SD interface and LCD controller.

The main elements of this architecture are:
Microprocessor running at 200 MHz
32 MB or 64 MB of fast synchronous DRAM (SDRAM) with low power self refresh. Arranged as two devices on a 32 bit wide 100 MHz bus
SD card interface for all non-volatile storage including the OS (No RAM drive)
Native (bare metal) boot loader stored in 256 KB of NOR Flash. This Flash device will contain a boot sector which is write protected to store protected data such as unique product ID's and manufacturing data.

Debug UART (RS232 3V levels) connected to the docking connector
USB client for PC connectivity
Integrated GPS receiver
Integrated two axis accelerometer
Optional integrated Bluetooth transceiver for PDA and mobile phone connectivity
High quality audio through I²S codec and amplifier

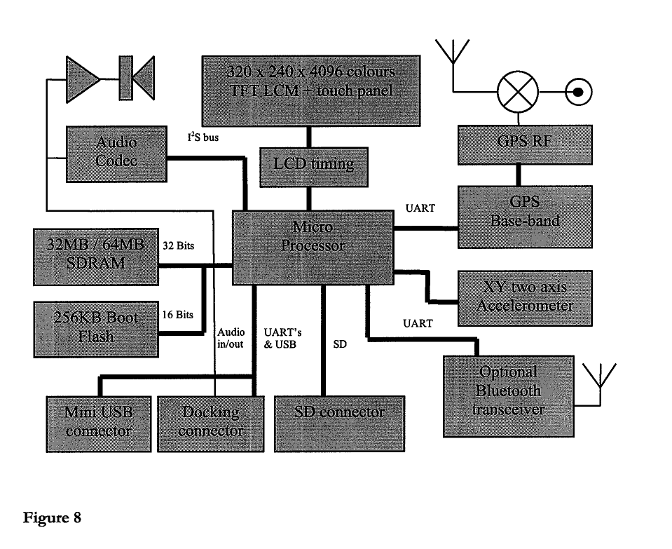

FIG. 8 is the GO block diagram.

### Power Management

GO will be powered from an integrated Li-Ion 2200 mAH rechargeable battery. This battery can be charged, and the device powered (even if the battery contains no charge) from an externally supplied +5V power source. This external +5V power source is supplied via the docking connector or a DC jack socket.

This +5V supply will be generated from the vehicle's main supply rail or from a mains adapter externally. The device will be turned on and off by a single button. When the device is turned off the DRAM contents will be preserved by placing the RAM in self-refresh so that when switched on GO will resume from where it was switched off There will also be a wake-up signal available through he docking connector, this can be used to auto-switch on GO when the vehicle ignition is switched on.

There will also be a small hidden reset switch.

### SYSTEM Memory Architecture

In contrast to conventional embedded devices which execute all the OS and application code in place from a large mask ROM or Flash device, GO will be based on a new memory architecture which is much closer to a PC.

This will be made up of three forms of memory:
4. A small amount of XIP (eXecute In Place) Flash ROM. This is analogous to the PC's BIOS ROM and will only contain a proprietary boot loader, E² emulation (for UID and manufacturing data) and splash screen bit maps. This is estimated to be 256 KB in size and would be on a slow 8 bit wide SRAM interface.
5. The main system memory, this is analogous to the PC's main memory (RAM). This will be where all the main code executes from as well as providing the video RAM and workspace for the OS and applications. Note: No persistent user data will be stored in the main system RAM (like a PC) i.e. there will be no “Ram drive”. This RAM will be exclusively connected to a 32 bit 100 MHz synchronous high-speed bus.

GO will contain two sites for 16 bit wide 256/512 Mbit SDRAM's allowing memory configurations of 32 MB (16 bit wide) 64 MB 32 bit wide and 128 MB (32 bit wide).
6. Non-volatile storage, analogous to the PC's hard disk. This is implemented as removable NAND flash based SD cards. These devices do not support XIP. All the OS, application, settings files and map data will be permanently stored on SD cards

### Audio

A 52 mm diameter speaker is housed in GO to give good quality spoken instructions. This will be driven by an internal amplifier and audio codec. Audio line out will also be present on the docking connector.

### SD Memory Slot

GO will contain one standard SD card socket. These are used to load system software and to access map data.

### Display

GO will use a transflective 3.5″ TFT backlit display It will be a ‘standard’ ¼VGA display as used by PocketPC PDA's. It will also contain a touch panel and bright CCRL backlight.

### Power Supplies

### Power Supply—Ac Adapter Socket

4.75V to 5.25V (5.00V+/−5%)@ 2 A

### Power Supply—Docking Connector

4.75V to 5.25V (5.00V+/−50%) @ 2 A

### Variants

It shall be possible to assemble and test the following variants of GO:

### Standard (Bluetooth Depopulated, 32 Mbyte RAM)

In the Standard variant the Bluetooth function is not populated, and 32 Mbytes RAM is fitted.

### Bluetooth Option (Future Variant)

The product design should include Bluetooth although it is not populated in the standard variant to minimise BOM cost. The design should ensure that all other functions (including GPS RF performance) operate without degradation when the Bluetooth function is operating.

### 64 Mbyte RAM Option (Future Variant)

The product design should ensure it is possible to fit 64 Mbyte RAM instead of 32 Mbyte. Subassemblies

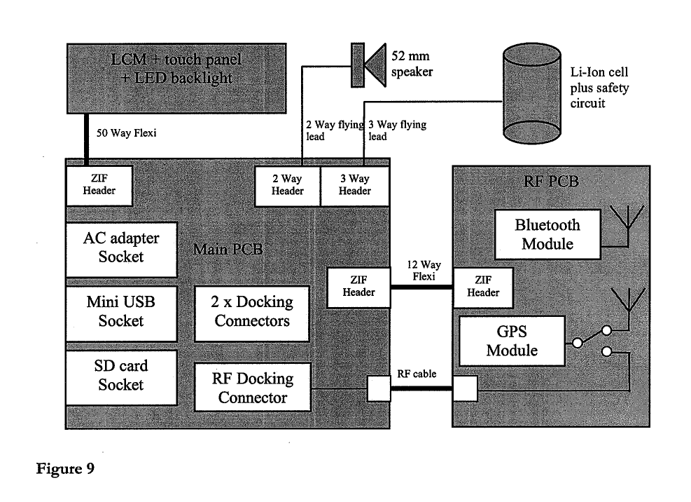

GO consists of the following electrical subassemblies, shown in FIG. 9.

### RF Cable

The RF cable feeds the RF signal from an external GPS antenna (which connects to GO via the RF docking connector) to the RF PCB where the GPS module is situated.

### External Connectors

### Docking Connectors

Two Docking Connectors provide an interface to external Docking Stations.

| | | | | |
|---|---|---|---|---|
| Pin | Signal | Dir | Type | Description |

Docking Connector #1 pinout

| | | | | |
|---|---|---|---|---|
| 1 | GND | — | — | Signal and power GND |
| 2 | GND | — | — | |
| 3 | DOCKSNS1 | I/P | PU | Docking Station Sense [0, 1] - These signals are |
| 4 | DOCKSNS0 | I/P | PU | connected to pull-up resistors within the unit. The |
| | | | | Docking Station pulls either or both of these signals to |
| | | | | GND to indicate the presence and type of Docking |
| | | | | Station. |
| 5 | AUDIOL | O/P | | Audio line outputs (Left and Right) to connect to car |
| 6 | AUDIOR | O/P | | audio system. |
| 7 | MUTE | O/P | O/D | The unit pulls this line to GND to signal the car audio |
| | | | | system to mute itself while the unit is issuing a voice |
| | | | | command. |
| 8 | IGNITION | I/P | PD | Ignition sense. |
| 9 | DOCKPWR | I/P | PWR | +5 V power from the Docking Station to |
| 10 | DOCKPWR | I/P | PWR | simultaneously power the unit and charge the battery. |

Docking Connector #2 pinout

| | | | | |
|---|---|---|---|---|
| 1 | TXD | O/P | UART | 3 V logic level UART signals |
| 2 | RXD | I/P | UART | |
| 3 | RTS | O/P | UART | |
| 4 | CTS | I/P | UART | |
| 5 | GND | — | PWR | |
| 6 | nTRST | I/P | JTAG | CPU JTAG signals for test and configuration |
| 7 | TMS | I/P | JTAG | |
| 8 | TCK | I/P | JTAG | |
| 9 | TDI | I/P | JTAG | |
| 10 | TDO | O/P | JTAG | |

PWR Power connection
O/D Open-Drain output
PU Pull-Up resistor within the unit
PD Pull-Down resistor within the unit

### RF Docking Connector

The RF Docking Connector allows connection of an external active GPS antenna via a Docking Station.

### AC Adapter Socket

The AC adapter socket allows power to be supplied from a low cost AC adapter or CLA (Cigarette Lighter Adapter).

### USB Connector

The USB connector allows connection to a PC by means of a standard mini USB cable.

### SD Card Socket

A hard locking SD card socket suitable for high vibration applications supports SDIO, SD memory and MMC cards.

(Although GO provides hardware support for SDIO, software support will not be available at the time of product introduction)

### Processor

The processor is the ARM920T based SOC (System on chip) operating at approx 200 Mhz.

### RAM

GO will be fitted with RAM to the following specification:

| | |
|---|---|
| Type | SDRAM with low-power refresh (“mobile” SDRAM) |
| Total memory | 32 Mbyte (standard) or 64 Mbyte (future option) |
| Bus width | 32-bit |
| Minimum speed | 100 Mhz |
| Maximum self | 500 μA per device |
| refresh current | |
| Configuration | 2 × 16-bit wide CSP sites |

### Flash Memory

GO will be fitted with a minimum of 256 kbyte of 16-bit wide Flash Memory to contain the following:
Boot loader code to enable loading of O/S from SD card
Factory set read-only protected manufacturing parameters (e.g. manufactured date) and unique ID E2PROM emulation)
User specific settings E2PROM emulation)

The following devices can be used depending on price and availability.:

### GPS Internal Antenna

The GPS internal antenna is attached directly to the RF PCB.

### GPS External (Active) Antenna Switching

When an external antenna is connected via the RF Docking Connector, the GPS antenna source is automatically switched to the external antenna.

### Accelerometer

A solid state accelerometer is connected directly to the processor to provide information about change of speed and direction.

### Auxiliary Functions

### Ignition Synchronization

### Ignition Wakeup

A rising edge on the Docking Station IGNITION signal will wakeup the unit. The IGNITION signal may be connected to a 12V or 24V vehicle battery.

### Ignition State Monitoring

The state of the Docking Station IGNITION signal is detected and fed to a GPIO pin to allow software to turn off the unit when the ignition signal goes low.

### Standard Peripherals

The following peripherals will be included as standard with GO.
Simple docking shoe. Mounts GO and allows charging through a DC jack. No other connectivity is included in the simple dock.
Cigarette lighter power cable connecting to GO through the DC jack socket or simple docking shoe.
Mini USB cable for PC connectivity
Universal mains adapter for connection to DC Jack socket

### Optional Peripherals

The following optional peripherals will be available at or after the time of launch of GO
Active antenna kit. Contains a GPS active antenna and a docking shoe with GPS RF connector and cable fitted. For self installation when an external antenna is required.
Professional vehicle docking kit. For fitting by professional installation only. Allows direct connection to vehicle supply, audio system and active antenna via a vehicle interface box.

1. A method of reporting errors in map data used by navigation devices, the method comprising the steps of:
a) displaying map data, suitable for route guidance algorithms, on an electronic navigation device;
b) an end-user of the device inputting a map error report directly on the device, the map error report comprising user generated error correction suggestions;
c) the device storing that map error report;
d) the device sending that map error report to a remote sever that can process that map error report.

2. The method of claim 1 in which the map error report is stored with a location reference.

3. The method of claim 1 in which the map error report is stored as a text entry.

4. The method of claim 1 in which the map error report is sent back to the sewer as part of synchronisation.

5. The method of claim 1 in which the remote server sends the map error reports to the original provider of the map data.

6. The method of claim 1 in which the entity controlling the server reduces the license fees it pays to a provider of the map data in exchange for supplying the map error reports.

7. Map data for a navigation device that has been developed at least in part using the method of claim 1.

8. An electronic navigation device storing map data as defined in claim 7.

9. An electronic navigation device adapted to store improved map data, the device:
a) displaying map data;
b) enabling an end-user to input a map error report, directly on the device, the map error report comprising user generated error correction suggestions; and
c) the device storing that map error report;
d) the device sending that map error report to a remote server that can process that map error report.

10. The navigation device of claim 9, being a portable stand-alone device.

11. The navigation device of claim 9, being a touch screen based device.

12. The navigation device of claim 9, being a mobile telephone.

13. The navigation device of claim 9, being a PC.

14. The navigation device of claim 9, being integrated into a vehicle.
